(19) United States
(12) Patent Application Publication
(10) Pub. No.: US 2026/0206827 A1
(43) Pub. Date: Jul. 23, 2026

(54) FRAGRANCE-CARRYING CONSTITUENT MEMBER OF FLAVOR-GENERATING ARTICLE AND METHOD FOR PRODUCING SAME, FLAVOR-GENERATING ARTICLE, AND COATING SOLUTION AND METHOD FOR PRODUCING SAME

(71) Applicant: Japan Tobacco Inc., Tokyo (JP)

(72) Inventors: Yasuo TANAKA, Tokyo (JP); Kuan Hsuan LIN, Tokyo (JP)

(73) Assignee: Japan Tobacco Inc., Tokyo (JP)

(21) Appl. No.: 19/137,689

(22) PCT Filed: Dec. 23, 2022
(86) PCT No.: PCT/JP2022/047723

§ 371 Date: Jun. 11, 2025

(51) Int. Cl. A24D 1/00; A24B 15/18; A24B 15/36; A24D 1/02; A24D 1/20

(52) U.S. Cl. CPC A24D 1/002; A24B 15/186; A24B 15/36; A24D 1/025; A24D 1/20

(57) ABSTRACT

The fragrance-carrying constituent member of a flavor-generating article includes a constituent member of the flavor-generating article and a fragrance composition that is carried on the constituent member and contains particles containing menthol and hydroxypropyl cellulose, the viscosity of a 2 mass % aqueous solution of which at 20° C. is 100 mPa·s or less, and glycerol as a dispersion medium.

### TECHNICAL FIELD

The present invention relates to fragrance-carrying constituent members of flavor-generating articles and methods of manufacturing thereof, as well as flavor-generating articles and coating liquids, and methods of manufacturing thereof.

### BACKGROUND ART

Among known flavor-generating articles comprising a flavor source such as a tobacco flavor source are flavor inhalers, from which a user tastes a flavor by inhaling, and smokeless tobacco, from which a user tastes a tobacco flavor by inserting the product directly into the nasal cavity or oral cavity. Flavor inhalers can be broadly divided into combustion-type flavor inhalers as represented by conventional cigarettes, heat-not-burn flavor inhalers known as heated tobacco products, and non-heated flavor inhalers from which a user inhales flavor without burning or heating the flavor source.

These flavor-generating articles must provide a stable flavor to the user over a period of use. However, there is a problem in that when volatile flavoring components such as menthol in the flavor-generating articles are added in solution to the flavor source, the flavoring components dissipate over lengthy periods of storage, and the flavoring effect does not persist. There have been various reports to date on solving the problem of flavoring component dissipation during storage.

For example, PTL 1 discloses that when a constituent member of a flavor-generating article is made to carry a coating liquid containing a fragrance and a fragrance retaining agent by being sprayed therewith, volatilization thereof can be inhibited and the fragrance incorporated into the flavor generating article.

### CITATION LIST

### Patent Literature

PTL 1 WO 2013/011899 A1

### SUMMARY OF INVENTION

### Technical Problem

The inventors focused on the problem whereby increasing the viscosity of a coating liquid containing a fragrance and a fragrance retaining agent may increase the difficulty of fragrance volatilization, but also increases the difficulty of applying the coating liquid to a constituent member of a flavor-generating article, whereas reducing the viscosity of a coating liquid may increase the ease of applying the coating liquid to a constituent member of a flavor-generating article, but also increases the ease of fragrance volatilization. The challenge confronted by the present invention is to solve the abovementioned problem, i.e. to achieve both ease of applying a coating liquid to a constituent member of a flavor-generating article and fragrance storage stability.

### Solution to Problem

A first aspect provides a fragrance-carrying constituent member of a flavor-generating article, comprising:
a constituent member of a flavor-generating article; and
a fragrance composition that is carried on the aforementioned constituent member, containing particles that comprise menthol and a hydroxypropyl cellulose having a viscosity of 100 mPa·s or less at 20° C. in a 2 mass % aqueous solution, and glycerol as a dispersion medium.

A second aspect provides a flavor-generating article, comprising the fragrance-carrying constituent member of the first aspect.

A third aspect provides a method of manufacturing a coating liquid for coating the constituent member of a flavor-generating article that comprises:
preparing a liquid mixture by mixing menthol and hydroxypropyl cellulose having a viscosity of 100 mPa·s or less at 20° C. in a 2 mass % aqueous solution at the melting point of menthol or a higher temperature; and
mixing the aforementioned liquid mixture with glycerol.

A fourth aspect provides a method of manufacturing a fragrance-carrying constituent member of a flavor-generating article that comprises:
manufacturing a coating liquid in accordance with the method of the third aspect; and applying the aforementioned coating liquid to the constituent member of the flavor-generating article.

A fifth aspect provides a coating liquid for coating a constituent member of a flavor-generating article that comprises particles containing menthol and hydroxypropyl cellulose having a viscosity of 100 mPa·s or less at 20° C. in a 2 mass % aqueous solution, and glycerol as a dispersion medium.

### Effects of Invention

The present invention enables achievement of both ease of coating liquid application to a constituent member of a flavor-generating article and fragrance storage stability.

### BRIEF DESCRIPTION OF DRAWINGS

FIG. 1 is a cross-sectional schematic view showing an example of a fragrance-carrying constituent member.

FIG. 2 is a flow chart showing a coating liquid preparation process.

FIG. 3A is a schematic front view showing an example of the aerosol-generating device.

FIG. 3B is a schematic top view of the aerosol-generating device shown in FIG. 3A.

FIG. 3C is a schematic bottom view of the aerosol-generating device shown in FIG. 3A.

FIG. 4 is a schematic cross-sectional side view showing an example of a tobacco stick.

FIG. 5 is a cross-sectional view along the III-III line of the aerosol-generating device shown in FIG. 3B.

FIG. 6 is a graph showing the viscosities of coating liquids.

FIG. 7 is a graph showing the viscosities of coating liquids.

FIG. 8 is a graph showing the menthol aroma retention of coating liquids.

FIG. 9 is a graph showing the menthol aroma retention of coating liquids.

FIG. 10 is a graph showing the relationship between viscosity and menthol aroma retention.

FIG. 11 is a graph showing the relationship between viscosity and menthol aroma retention.

FIG. 12 is a graph showing a transmission spectrum of coating liquids.

FIG. 13 is a graph showing the relationship between viscosity and menthol aroma retention.

FIG. 14 is a graph showing the relationship between puff count and menthol content.

FIG. 15 is a graph showing the relationship between puff count and glycerol content.

### MODES FOR CARRYING OUT INVENTION

The present inventors have newly discovered that a coating liquid with low viscosity but high fragrance storage stability can be provided if a coating liquid, containing low-viscosity hydroxypropyl cellulose, menthol, and glycerol, is prepared by the specific process shown in FIG. 2.

### <1> Fragrance-Carrying Constituent Member

A fragrance-carrying constituent member of a flavor-generating article (hereinafter simply referred to as a “fragrance-carrying constituent member”) comprises:
a constituent member of a flavor-generating article; and
a fragrance composition that is carried on the aforementioned constituent member, containing particles that comprise menthol and a hydroxypropyl cellulose having a viscosity of 100 mPa·s or less at 20° C. in a 2 mass % aqueous solution, and glycerol as a dispersion medium.

### (Flavor-Generating Article)

Flavor-generating articles encompass flavor inhalers from which a user inhales a flavor (e.g. tobacco flavor) and smokeless tobacco products that a user inserts directly into the nasal cavity or oral cavity to taste the tobacco flavor.

A flavor inhaler is any inhaler comprising a flavor source, with which the user tastes a flavor derived from the flavor source by inhaling. The flavor source included in the flavor inhaler is preferably a tobacco flavor source. Specific flavor inhalers include combustion-type flavor inhalers that provide flavor to a user by burning a flavor source; heat-not-burn flavor inhalers (also referred to as heated tobacco sticks) that provide flavor to a user by heating without burning the flavor source; and non-heating flavor inhalers that provide flavor to a user without burning or heating the flavor source.

Smokeless tobacco is a product that contains a flavor source, and from which the user tastes the flavor derived from the flavor source by inserting the product directly into the nasal cavity or oral cavity. The flavor source included in smokeless tobacco is preferably a tobacco flavor source. Snuff and chewing tobacco are known types of smokeless tobacco.

### (Constituent Member of a Flavor-Generating Article)

The “constituent member of a flavor-generating article” is a base member for carrying the fragrance composition. For this reason, the constituent member of the flavor-generating article is also referred to as a “base member” in the following description.

The base member is for example a tobacco filler. A tobacco filler is a tobacco material that serves as a tobacco flavor source in a flavor-generating article. The tobacco filler material may be, for example, cut tobacco, shaped tobacco (e.g. sheet tobacco or tobacco granules), or a combination thereof. Cut tobacco means cut tobacco leaves (i.e., dried tobacco leaves) that are ready to be incorporated into a flavor-generating article. Sheet tobacco means shaped tobacco that is a tobacco material, such as tobacco debris or cut tobacco produced from leaf debris, shredded debris, etc. in raw material factories and manufacturing factories, that is formed into a sheet, or a cut product thereof. Tobacco granules are a tobacco material such as tobacco debris or cut tobacco produced from leaf debris, shredded debris, etc. in raw material factories and manufacturing factories, that is shaped into the form of granules.

When the base member is a tobacco filler in the present description, the fragrance-carrying constituent member is referred to as a “fragrance-carrying tobacco filler.” The fragrance-carrying constituent member is specifically referred to as a “fragrance-carrying shaped tobacco” when the base member is a shaped tobacco. Similarly, the fragrance-carrying constituent member is referred to as a “fragrance-carrying sheet tobacco” when the base member is sheet tobacco.

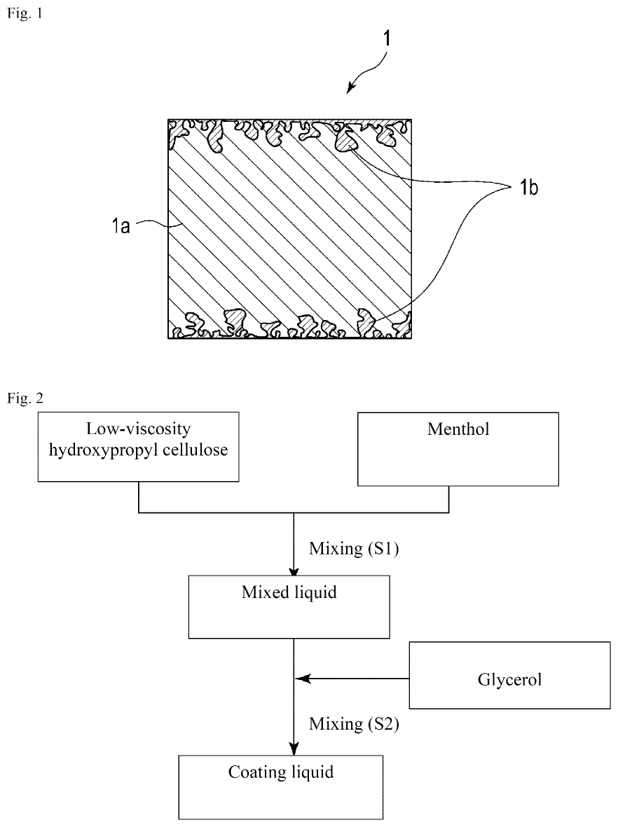

An example of a fragrance-carrying constituent member, with sheet tobacco used as the base member, is shown in FIG. 1. FIG. 1 shows a fragrance-carrying sheet tobacco 1 with a fragrance composition 1b formed on the sheet tobacco 1a. Since the sheet tobacco 1a has voids, the fragrance composition 1b has entered voids in the sheet tobacco 1a in FIG. 1.

Alternatively, the base member may be a cigarette rolling paper. The cigarette rolling paper is a rolling paper for wrapping the tobacco filler in the flavor inhaler.

Alternatively, the base member may be a filter. Specifically, the base member may be a filtration material (e.g. cellulose acetate fiber, paper, or a film) constituting a filter, or a plug wrapper wrapped around the filtration material. When the base member is a filtration material constituting a filter, the fragrance-carrying constituent member is referred to as a “fragrance-carrying filtration material.”

### (Fragrance Composition)

The “fragrance composition” is carried on the base member and comprises the following components:
hydroxypropyl cellulose having a viscosity of 100 mPa·s or less at 20° C. in a 2 mass % aqueous solution;
menthol; and
glycerol.

In the following description, “hydroxypropyl cellulose having a viscosity of 100 mPa·s or less at 20° C. in a 2 mass % aqueous solution” is also referred to as “low-viscosity hydroxypropyl cellulose.”

The fragrance composition can be formed by coating the base member with a coating liquid comprising low-viscosity hydroxypropyl cellulose, menthol, and glycerol, and drying the base member, which has been coated with the coating liquid. Drying can for example be performed by leaving the base member, coated with the coating liquid, at room temperature (e.g. 15-25° C.). Drying should continue until the coating liquid visibly solidifies. The fragrance composition may be present so as to form a layer on the surface of a constituent member of the flavor-generating article, or may be present only in recesses when there are irregularities in the surface of the constituent member of the flavor-generating article.

The “low-viscosity hydroxypropyl cellulose” used in the present invention has a viscosity of 100 mPa·s or less at 20° C. in a 2 mass % aqueous solution. The viscosity at 20° C. in a 2 mass % aqueous solution of the hydroxypropyl cellulose used in the present invention is preferably 50 mPa·s or less, more preferably 30 mPa·s or less, and still more preferably 10 mPa·s or less. The lower limit of viscosity is not specifically restricted, and is for example 1.0 mPa·s.

In the present explanation, viscosity at 20° C. in a 2 mass % aqueous solution refers to viscosity as measured with a B-type viscometer at 20° C. and 60 rpm (JIS Z8803: 2011).

Low-viscosity hydroxypropyl cellulose is commercially available, and examples include Celny SSL (viscosity at 20° C. in a 2 mass % aqueous solution: 2.0-2.9 mPa·s, Nippon Soda Co., Ltd.), Celny SL (viscosity at 20° C. in a 2 mass % aqueous solution: 3.0-5.9 mPa·s, Nippon Soda Co., Ltd.), and Celny L (viscosity at 20° C. in a 2 mass % aqueous solution: 6.0-10.0 mPa·s, Nippon Soda Co., Ltd.)

The low-viscosity hydroxypropyl cellulose content of the fragrance composition is preferably 20-70 parts by mass to 100 parts by mass of menthol. The low-viscosity hydroxypropyl cellulose content of the fragrance composition is more preferably 30-70 parts by mass, and still more preferably 40-60 parts by mass to 100 parts by mass of menthol.

The glycerol content of the fragrance composition is preferably 40-120 parts by mass to 100 parts by mass of menthol. The glycerol content of the fragrance composition is more preferably 60-110 parts by mass, and still more preferably 80-100 parts by mass to 100 parts by mass of menthol.

### <2> Method of Manufacturing Fragrance-Carrying Constituent Member

The abovementioned fragrance-carrying constituent members can be manufactured by the method described below. That is, another aspect provides a method of manufacturing a constituent member of a flavor-generating article that includes:
preparing a liquid mixture by mixing menthol and hydroxypropyl cellulose having a viscosity of 100 mPa·s or less at 20° C. in a 2 mass % aqueous solution at the melting point of menthol or a higher temperature;
mixing the aforementioned liquid mixture with glycerol to prepare a coating liquid; and
applying the aforementioned coating liquid to a constituent member of a flavor-generating article.

The coating liquid preparation process and the subsequent coating process of the coating liquid are described in order below.

### <2-1> Coating Liquid Preparation Process

The coating liquid preparation process is shown in FIG. 2. As shown in FIG. 2, a low-viscosity hydroxypropyl cellulose and menthol are first mixed (S1) at the melting point of menthol or a higher temperature, and the resulting mixture is mixed with glycerol (S2) to prepare a coating liquid.

The melting point of menthol is approximately 43° C. “The melting point of menthol or a higher temperature” thus denotes a temperature of 43° C. or higher. Consequently, the low-viscosity hydroxypropyl cellulose and menthol mixing step (S1) may be performed at a temperature within a range of, for example, 45-100° C., preferably 50-100° C., or more preferably 60-100° C. The step of mixing the mixture with glycerol (S2) may be performed at any temperature, but preferably at the same temperature as the mixing step (S1).

The composition preferred for the coating liquid is the same as that preferred for the fragrance composition. That is, the low-viscosity hydroxypropyl cellulose content of the coating liquid is preferably 20-70 parts by mass to 100 parts by mass of menthol. The low-viscosity hydroxypropyl cellulose content of the coating liquid is more preferably 30-70 parts by mass, and still more preferably 40-60 parts by mass to 100 parts by mass of menthol. The glycerol content of the coating liquid is preferably 40-120 parts by mass to 100 parts by mass of menthol. The glycerol content of the coating liquid is more preferably 60-110 parts by mass, and still more preferably 80-100 parts by mass to 100 parts by mass of menthol.

Preparation of the coating liquid through use of the two-stage mixing process shown in FIG. 2 allows to obtain a “low-viscosity, cloudy coating liquid” (see Examples 1 and 4 below).

The present inventors consider the reason that a “low-viscosity, cloudy coating liquid” is obtained to be as follows. In the first mixing step (S1), hydroxypropyl cellulose is dissolved in menthol. When glycerol is admixed in the subsequent mixing step (S2), a hydroxypropyl cellulose and menthol mixture phase is intermixed with a glycerol phase, and upon stirring thereof, the hydroxypropyl cellulose and menthol mixture is thought to be dispersed in the glycerol in the form of droplets. It is thought that, under the circumstances, hydroxypropyl cellulose interacts with glycerol at the interfaces between the droplets and menthol, and the hydroxypropyl cellulose and menthol mixture is present in droplets, with the menthol protected by interaction between the hydroxypropyl cellulose and glycerol. That is, it appears that the “low-viscosity, cloudy coating liquid” has particles comprising hydroxypropyl cellulose and menthol dispersed colloidally in glycerol.

On the other hand, a “low-viscosity, cloudy coating liquid” cannot be obtained by mixing the low-viscosity hydroxypropyl cellulose, menthol, and glycerol all together at the same time to prepare a coating liquid, which generates solid matter (see example 1 below). This solid matter appears to be a reaction product of glycerol and hydroxypropyl cellulose.

### <2-2> Coating Liquid Coating Process

A fragrance-carrying constituent member can be manufactured by coating a constituent member of the flavor-generating article with the abovementioned coating liquid. Coating may be performed by any method, provided that the coating liquid is applied to the surface of the constituent member of the flavor-generating article. For example, coating may be performed by extrusion and thus addition of the coating liquid onto the surface of the constituent member of the flavor-generating article, using a slit feeder, or by applying the coating liquid onto the surface of the constituent member of the flavor-generating article with a film applicator or the like.

As indicated above, the coating liquid is dried and solidified after the constituent member of the flavor-generating article is coated therewith. When solidified, the coating liquid is referred to as a “fragrance composition.”

### <2-3> Effects

The “low-viscosity, cloudy coating liquid” is superior in terms of ease of application to the constituent member of the flavor-generating article due to the low viscosity thereof. The “low-viscosity, cloudy coating liquid” is also excellent in terms of high menthol storage stability after application to the constituent member of the flavor-generating article. In addition, a fragrance-carrying constituent members manufactured using the “low-viscosity, cloudy coating liquid” is excellent in terms of enabling stable release of menthol throughout the puff period of the flavor inhaler. These effects are demonstrated in coating liquids 1E and 2E in Examples 1-3, coating liquids 10A and 10B in Example 4, and Examples 5 and 6, described below.

### <3> Coating Liquid and Manufacturing Method Thereof

The abovementioned coating liquid and method of manufacturing thereof are one aspect of the invention. That is, still another aspect provides a method of manufacturing a coating liquid for coating a constituent member of a flavor-generating article, comprising:
preparing a liquid mixture by mixing menthol and hydroxypropyl cellulose having a viscosity of 100 mPa·s or less at 20° C. in a 2 mass % aqueous solution at the melting point of menthol or a higher temperature; and
mixing the aforementioned liquid mixture with glycerol.

The method of manufacturing the coating liquid can be carried out as described in the “<2-1> Coating liquid preparation process” section.

Still another aspect provides a coating liquid produced by the “method of manufacturing the coating liquid” described above. As indicated above, this coating liquid apparently has particles comprising hydroxypropyl cellulose and menthol colloidally dispersed in the glycerol. Still another aspect provides a coating liquid for coating a constituent member of a flavor-generating article that comprises particles, containing menthol and hydroxypropyl cellulose having a viscosity of 100 mPa·s or less at 20° C. in a 2 mass % aqueous solution, and glycerol as a dispersion medium.

The abovementioned coating liquid is characterized by having a transmittance of 10% or less over the entire wavelength range of 500-700 nm when a transmission spectrum is obtained over a wavelength range of 500-700 nm using a spectrophotometer (see example 4 below). That is, the abovementioned coating liquid is characterized in that it is cloudy. The abovementioned coating liquid is also characterized in that it has a low viscosity, as indicated above.

Use of such a coating liquid to produce the fragrance-carrying constituent member, as indicated above, enables achievement of both ease of coating liquid application to a constituent member of a flavor-generating article and fragrance storage stability.

### <4> Flavor-Generating Article

The abovementioned “fragrance-carrying constituent member” can be integrated into any flavor-generating article. That is, another aspect provides a flavor-generating article comprising the “fragrance-carrying constituent member” described above.

The flavor generating article of the present invention has the same configuration as an ordinary flavor generating article, except that the constituent member of an ordinary flavor-generating article has been replaced with the “fragrance-carrying constituent member” described above. In the flavor-generating article of the present invention, the abovementioned “fragrance-carrying constituent member” may replace a plurality of constituent members (e.g. a tobacco filler and a filter) of an ordinary flavor-generating article, or the abovementioned “fragrance-carrying constituent member” may replace one constituent member (e.g. a tobacco filler) of an ordinary flavor-generating article. Moreover, when the abovementioned “fragrance-carrying tobacco filler material” replaces the tobacco filler, the abovementioned “fragrance-carrying tobacco filler” may replace all of the tobacco filler material, or the abovementioned “fragrance-carrying tobacco filler” may replace some of the tobacco filler.

As indicated above, flavor-generating articles include combustion-type flavor inhalers, heat-not-burn flavor inhalers, non-heating flavor inhalers, and smokeless tobacco.

A “combustion-type flavor inhaler” is a flavor inhaler that provides a flavor to a user by burning a flavor source such as a tobacco filler (e.g. cut tobacco or shaped tobacco). Examples of combustion-type flavor inhalers include cigarettes, pipes, kiseru (Japanese smoking pipes), cigars, and cigarillos.

A “heat-not-burn flavor inhaler” is a flavor inhaler that provides flavor to a user by heating without burning a flavor source, such as a tobacco filler. As examples of non-heating type flavor inhalers, a carbon heat source flavor inhaler that heats a tobacco filler with heat from combustion of a carbon heat source (see e.g. WO 2006/073065);

an electrically heated flavor inhaler comprising a tobacco stick that contains a tobacco filler material, and a heating device for electrically heating the tobacco stick (see for example WO 2010/110226); or a liquid-atomizing flavor inhaler whereby a liquid aerosol source is heated through use of a heater to generate an aerosol, and a flavor derived from the tobacco filler is inhaled together with the aerosol (see e.g. WO2015/046385) may be cited.

A “non-heating flavor inhaler” is a flavor inhaler that provides flavor to a user without burning or heating a flavor source such as a tobacco filler. An example of a non-heating flavor inhaler is a non-heating tobacco flavor inhaler (see for example WO 2012/023515) comprising an inhaler body having an airflow passage through which air is circulated by inhalation, and tobacco granules arranged in the airflow passage.

A “smokeless tobacco” is a product that a user inserts directly into the nasal cavity or oral cavity to taste a tobacco flavor. The former is referred to as a nasal tobacco product, and the latter as an oral tobacco product. An example of the former is snuff, and an example of the latter is chewing tobacco.

A preferred aspect enables integration of the abovementioned “fragrance-carrying constituent member” into the flavor inhaler. The flavor inhaler is more preferably a heat-not-burn flavor inhaler.

A preferred embodiment provides a heat-not-burn flavor inhaler comprising:
a tobacco stick containing a flavor source, which comprises the abovementioned “fragrance-carrying tobacco filler” (e.g. a fragrance-carrying shaped tobacco), and a rolling paper wrapped around the aforementioned flavor source; and
a heater to heat the aforementioned flavor source that is contained in the aforementioned tobacco stick. The tobacco stick may further comprise a filter that is downstream of the flavor source (i.e. on the mouth side).

Another preferred embodiment provides a heat-not-burn flavor inhaler comprising: a tobacco stick comprising a flavor source comprising a tobacco filler, a tip plug arranged upstream of the flavor source (i.e., on the side opposite to a mouthpiece) and comprising a “fragrance-carrying filtration material,” and a rolling paper wrapped around the flavor source and the tip plug; and a heater to heat the aforementioned flavor source that is contained in the aforementioned tobacco stick.

### [Example of a Heat-not-Burn Flavor Inhaler]

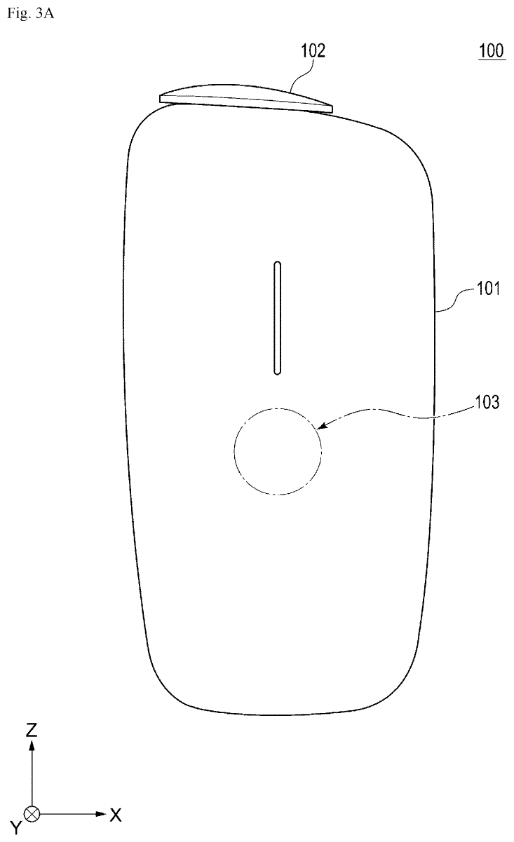

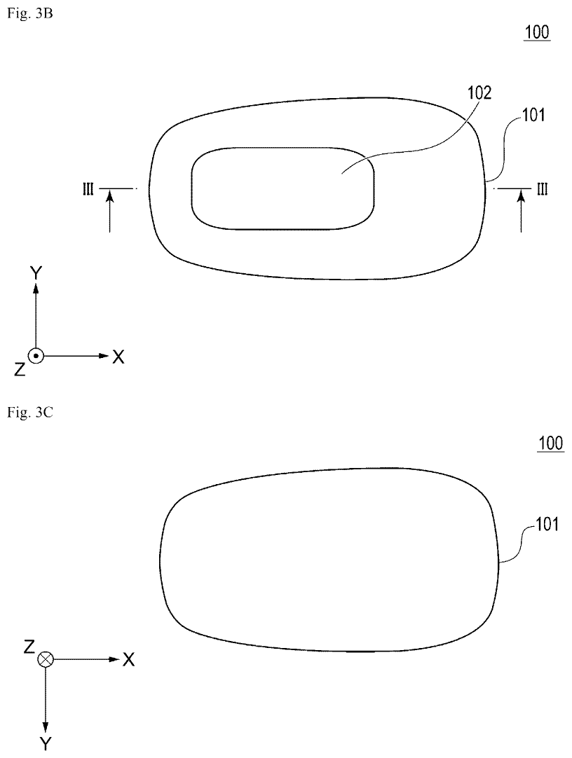

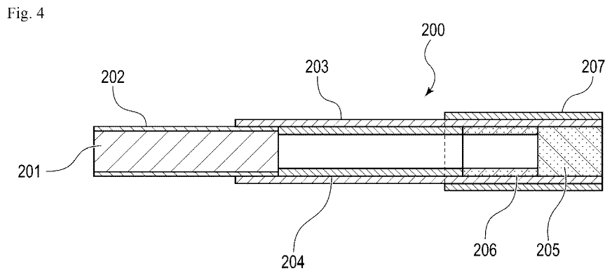

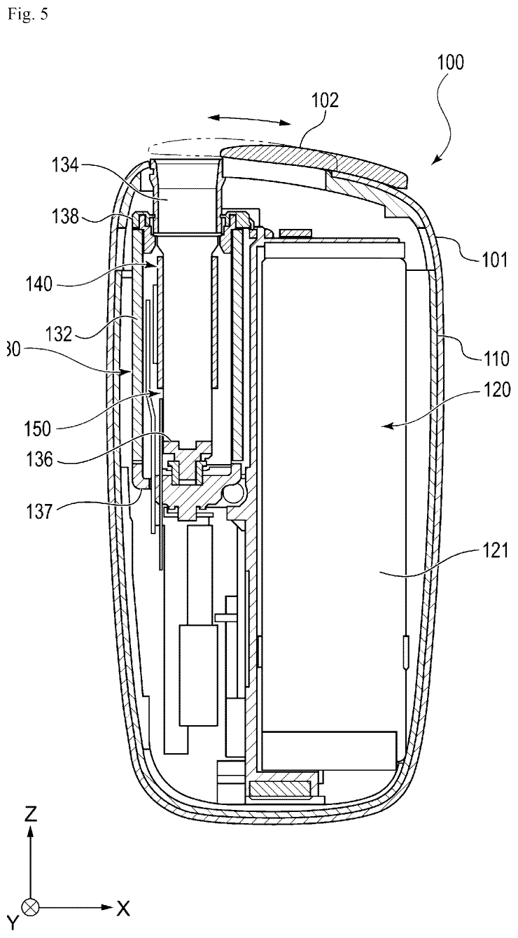

An example of a heat-not-burn smoking system is described below with reference to FIGS. 3A, 3B, 3C, 4, and 5. In the present example, the heat-not-burn flavor inhaler comprises an aerosol-generating device 100 and a tobacco stick 200. FIG. 3A is a schematic front view of an example of the aerosol-generating device. FIG. 3B is a schematic top view of the aerosol-generating device shown in FIG. 3A. FIG. 3C is a schematic bottom view of the aerosol-generating device shown in FIG. 3A. FIG. 4 is a schematic cross-sectional side view of an example of a tobacco stick. FIG. 5 is a cross-sectional view along the III-III line of the aerosol-generating device shown in FIG. 3B.

An X-Y-Z Cartesian coordinate system may be applied to the drawings to facilitate description. In this coordinate system, the Z-axis is oriented vertically upwards, the X-Y plane is arranged to cut horizontally across the aerosol-generating device 100, and the Y-axis is arranged to extend from the front surface to the rear surface of the aerosol-generating device 100. The Z-axis may refer to the insertion direction of a tobacco stick to be accommodated in a chamber 150 of an atomizing unit 130, described below, or to the axial direction of the chamber 150. Moreover, the X-axis is a direction perpendicular to the Y-axis and the Z-axis, and the X-axis and Y-axis are radial directions perpendicular to the axial direction of the chamber 150 or radial direction of the chamber 150.

The aerosol-generating device 100 is, for example, configured to generate an aerosol containing a flavor by heating a stick-type consumable material comprising the abovementioned “fragrance-carrying tobacco filler.”

As shown in FIGS. 3A-3C, the aerosol-generating device 100 comprises an outer housing 101 (equivalent to an example of a case), a sliding cover 102, and a switch unit 103. The outer housing 101 constitutes the outermost housing of the aerosol-generating device 100, and is sized to fit in a user's hand. When the user is using the flavor aerosol-generating device 100, the user can manually hold the aerosol-generating device 100 to inhale the aerosol. The outer housing 101 may be configured by assembling a plurality of members. The outer housing 101 is, for example, made of resin, and may specifically be formed from e.g. a polycarbonate (PC), an acrylonitrile butadiene styrene (ABS) resin, polyether ether ketone (PEEK), a polymer alloy containing multiple types of polymer, or a metal such as aluminum.

The outer housing 101 has an opening (not shown) for receiving a tobacco stick, and the sliding cover 102 is slidably attached to the outer housing 101 to close the opening. More specifically, the sliding cover 102 is configured to be capable of moving along an outer surface of the outer housing 101 between a closed position (the position shown in FIGS. 3A and 3B) for closing the opening of the outer housing 101, and an open position for opening the abovementioned opening (the position shown in FIG. 5). For example, the user can move the sliding cover 102 between the closed position and the open position by manipulating the sliding cover 102. Access of the tobacco stick to the interior of the aerosol-generating device 100 would thereby be allowed or restricted.

The switch unit 103 is used to switch operation of the aerosol-generating device 100 on and off. For example, a user may heat without burning a tobacco stick by operating the switch unit 103, with the tobacco stick inserted into the aerosol-generating device 100, to supply power to a heater (see reference sign 140 in FIG. 5) from a power source (see reference sign 121 in FIG. 5). Note that the switch unit 103 may be a switch provided outside the outer housing 101, or may be a switch located inside the outer housing 101. If the switch is located inside the outer housing 101, the switch is indirectly pressed by pressing a switch unit 103 on the surface of the outer housing 101. In the example described here, the switch of the switch unit 103 is located inside the outer housing 101.

The aerosol-generating device 100 may further have a terminal (not shown). The terminal may for example be an interface for connecting the aerosol-generating device 100 to an external power source. If the power source included in the aerosol-generating device 100 is a rechargeable battery, connecting an external power source to the terminal allows a current to flow from the external power source to the power source, thereby charging the power source. Furthermore, sending of data relating to operation of the aerosol-generating device 100 to an external device may also be enabled by connecting a data transmission cable to the terminal.

A tobacco stick to be used with the aerosol-generating device 100 is described next. FIG. 4 is a schematic cross-sectional side view of a tobacco stick 200. In this example, the flavor inhaler is configured from the aerosol-generating device 100 and the tobacco stick 200. As shown in FIG. 4, the tobacco stick 200 comprises a smokable material 201, a tubular member 204, a hollow filter section 206, and a filter section 205.

The smokable material 201 is wrapped with a first rolling paper 202. The tubular member 204, the hollow filter section 206, and the filter section 205 are wrapped with a second rolling paper 203 that is different from the first rolling paper 202. The second wrapping paper 203 also wraps a part of the first wrapping paper 202 that wraps the smokable material 201. Thereby the tubular member 204, the hollow filter section 206, and the filter section 205 are linked to the smokable material 201. However, the second rolling paper 203 may be omitted, and the first rolling paper 202 may be used to link the tubular member 204, the hollow filter section 206, and the filter section 205 to the smokable material 201. A lip release agent 207 is applied to the outer surface of the second rolling paper 203, near the end on the filter section 205 side, to facilitate separation of the user's lips from the second rolling paper 203. The part of the tobacco stick 200 to which the lip release agent 207 is applied functions as a mouthpiece of the tobacco stick 200.

The smokable material 201 comprises the above-described “fragrance-carrying tobacco filler” as a flavor source. As noted above, the “fragrance-carrying tobacco filler” may be used alone as a flavor source for a heat-not-burn flavor inhaler or may be mixed with a tobacco filler ordinarily used in heat-not-burn flavor inhalers and used as a flavor source. The fragrance-carrying tobacco filler is for example a fragrance-carrying shaped tobacco. The fragrance-carrying shaped tobacco is for example a fragrance-carrying sheet tobacco.

Moreover, the first wrapping paper 202 that wraps the smokable material 201 may be a breathable sheet member. The tubular member 204 may be a paper tube or a hollow filter. In the present example, the tobacco stick 200 comprises the smokable material 201, the tubular member 204, the hollow filter section 206, and the filter section 205, but the configuration of the tobacco stick 200 is not limited to this. For example, the hollow filter section 206 may be omitted, and the tubular member 204 and filter section 205 may be arranged adjacent to each other.

The internal structure of the aerosol-generating device 100 is described next. FIG. 5 is a cross-sectional view along the III-III line of the aerosol-generating device 100 shown in FIG. 3B. As shown in FIG. 5, an inner housing 110 (equivalent to an example of a case) is provided inside the outer housing 101 of the aerosol-generating device 100. The inner housing 110 is made of resin, for example, and may specifically be formed from e.g. a polycarbonate (PC), an acrylonitrile butadiene styrene (ABS) resin, polyether ether ketone (PEEK), a polymer alloy containing multiple types of polymer, or a metal such as aluminum. Note that from the perspective of heat resistance and strength, the inner housing 110 is preferably PEEK. The power source unit 120 and the atomizing unit 130 are provided in an internal space of the inner housing 110.

The power source unit 120 includes a power source 121. The power source 121 may be a rechargeable battery or a non-rechargeable battery, for example. The power source 121 is electrically connected to the atomizing unit 130. The power source 121 is thereby able to supply power to the atomizing unit 130, in order to heat the tobacco stick 200 properly.

The atomizing unit 130 comprises a metal chamber 150 (corresponding to an example of a tubular segment) extending in the insertion direction (i.e., Z-axis direction) of the tobacco stick 200 as shown in FIG. 5, a heater 140 covering a section of the chamber 150, an insulating section 132, and an approximately tubular insertion guiding member 134 (corresponding to an example of a guiding section) that abuts the opening of the chamber 150. The chamber 150 is configured to surround the tobacco stick 200. The heater 140 is configured to be in contact with the outer circumferential surface of the chamber 150, and thus to heat the tobacco stick 200 inserted into the chamber 150.

As also shown in FIG. 5, the bottom of the chamber 150 is provided with a bottom member 136 (corresponding to an example of an contact unit). The bottom member 136 may come into contact with the tobacco stick 200, inserted into the chamber 150, in the insertion direction of the tobacco stick 200, and act as a stopper to position the tobacco stick 200. In this case, the chamber 150 and the bottom member 136 constitute a storage section for accommodating at least a part of the tobacco stick 200. The bottom member 136 may, for example, be formed from a resin material. The bottom member 136 may have unevenness in the surface thereof, with which the tobacco stick 200 comes into contact, and which may define a first airflow path capable of supplying air to the air inlet of the tobacco stick 200 (i.e. in communication with the tobacco stick 200 received in the storage portion). The bottom member 136 is, for example, made of resin, and may specifically be formed from e.g. a polycarbonate (PC), an acrylonitrile butadiene styrene (ABS) resin, a polyether ether ketone (PEEK), a polymer alloy containing multiple types of polymer, or a metal such as aluminum. Note that the bottom member 136 is preferably formed of a material of low thermal conductivity, in order to inhibit heat transfer to the insulating section 132, etc.

The insulating section 132 is approximately tubular as a whole, and is arranged to surround the chamber 150. The insulating section 132 may contain an aerogel sheet, for example. The insertion guide member 134 is provided between the sliding cover 102 in the closed position and the chamber 150. The insertion guide member 134 is made of resin, for example, and may specifically be formed from e.g. a polycarbonate (PC), an acrylonitrile butadiene styrene (ABS) resin, polyether ether ketone (PEEK), a polymer alloy containing multiple types of polymer, or a metal such as aluminum. Note that the insertion guide member 134 may be formed from e.g. metal, glass, or a ceramic. Moreover, from the perspective of heat resistance, the insertion guide member 134 is preferably PEEK. The insertion guide member 134 communicates with the outside of the aerosol-generating device 100 when the sliding cover 102 is in the open position, and guides the insertion of the tobacco stick 200 into the chamber 150 when the tobacco stick 200 is inserted into the insertion guide member 134. Provision of the insertion guide member 134 facilitates insertion of the tobacco stick 200 into the chamber 150.

The aerosol-generating device 100 also has a first holding unit 137 and a second holding unit 138, which hold both ends of the chamber 150 and the insulating section 132. The first holding unit 137 is arranged to directly or indirectly hold the ends of the chamber 150 and the insulating section 132 on the negative Z-axis side. The second holding unit 138 is arranged to hold end portions of the chamber 150 and the insulating section 132 on the sliding cover 102 side (positive Z-axis side).

### <5> Preferred Embodiments

Preferred embodiments are summarized below.
[A1] A fragrance-carrying constituent member of a flavor-generating article comprising a constituent member of a flavor-generating article; and
a fragrance composition that is carried on the aforementioned constituent member, containing particles that comprise menthol and a hydroxypropyl cellulose having a viscosity of 100 mPa·s or less at 20° C. in a 2 mass % aqueous solution, and glycerol as a dispersion medium.
[A2] The fragrance-carrying constituent member set forth in [A1], wherein the aforementioned viscosity of the aforementioned hydroxypropyl cellulose is 50 mPa·s or less, preferably 30 mPa·s or less, more preferably 10 mPa·s or less, and still more preferably 6 mPa·s or less.
[A3] The fragrance-carrying constituent member set forth in [A1], wherein the aforementioned viscosity of the aforementioned hydroxypropyl cellulose is 1-100 mPa·s, preferably 1-50 mPa·s, more preferably 1-30 mPa·s, still more preferably 1-10 mPa·s, still more preferably 2-10 mPa·s, and still more preferably 2-6 mPa·s.
[A4] The fragrance-carrying constituent member set forth in any one of [A1]-[A3], wherein the aforementioned hydroxypropyl cellulose content of the aforementioned fragrance composition is 20-70 parts by mass, preferably 30-70 parts by mass, and more preferably 40-60 parts by mass to 100 parts by mass of the aforementioned menthol.
[A5] The fragrance-carrying constituent member set forth in any one of [A1]-[A4], wherein the aforementioned glycerol content of the aforementioned fragrance composition is 40-120 parts by mass, preferably 60-110 parts by mass, and more preferably 80-100 parts by mass to 100 parts by mass of the fragrance composition.
[A6] The fragrance-carrying constituent member set forth in any one of [A1]-[A5], wherein the aforementioned flavor-generating article is a flavor inhaler, preferably a heat-not-burn flavor inhaler.
[A7] The fragrance-carrying constituent member set forth in any one of [A1]-[A6], wherein the aforementioned constituent member of a flavor-generating article is a tobacco filler, a filter, or a cigarette rolling paper.
[A8] The fragrance-carrying constituent member set forth in any one of [A1]-[A7], wherein the aforementioned constituent member of a flavor-generating article is a shaped tobacco, a filter, or a cigarette rolling paper.
[A9] The fragrance-carrying constituent member set forth in any one of [A1]-[A8], wherein the aforementioned constituent member of a flavor-generating article is a tobacco filler, preferably a shaped tobacco, and more preferably a sheet tobacco.
[B1] A flavor-generating article comprising a fragrance-carrying constituent member set forth in any one of [A1]-[A9].
[B2] The flavor-generating article set forth in [B1], wherein the flavor-generating article is a flavor inhaler, preferably a heat-not-burn flavor inhaler.
[C1] A method of manufacturing a coating liquid for coating a constituent member of a flavor-generating article that comprises preparation of a liquid mixture by mixing menthol and hydroxypropyl cellulose having a viscosity of 100 mPa·s or less at 20° C. in a 2 mass % aqueous solution at the melting point of menthol or a higher temperature; and mixing the aforementioned liquid mixture with glycerol.
[C2] The method set forth in [C1], wherein the coating liquid has a transmittance of 10% or less over the entire wavelength range of 500-700 nm.
[C3] The method set forth in [C1] or [C2], wherein the aforementioned viscosity of the aforementioned hydroxypropyl cellulose is 50 mPa·s or less, preferably 30 mPa·s or less, more preferably 10 mPa·s or less, and still more preferably 6 mPa·s or less.
[C4], The method set forth in [C1] or [C2], wherein the aforementioned viscosity of the aforementioned hydroxypropyl cellulose is 1-100 mPa·s, preferably 1-50 mPa·s, more preferably 1-30 mPa·s, still more preferably 1-10 mPa·s, still more preferably 2-10 mPa·s, and still more preferably 2-6 mPa·s.
[C5] The method set forth in any one of [C1]-[C4] wherein the aforementioned hydroxypropyl cellulose is mixed with the aforementioned menthol in the amount of 20-70 parts by mass, preferably 30-70 parts by mass, and more preferably 40-60 parts by mass to 100 parts by mass of the aforementioned menthol.
[C6] The method set forth in any one of [C1]-[C5], wherein the glycerol is mixed with the aforementioned liquid mixture in the amount of 40-120 parts by mass, preferably 60-110 parts by mass, and more preferably 80-100 parts by mass to 100 parts by mass of the aforementioned menthol.
[C7] The method set forth in any one of [C1]-[C6], wherein the aforementioned temperature of the melting point of menthol or higher is a temperature of 43° C. or higher, preferably 45-100° C. or higher, more preferably 50-100° C. or higher, and still more preferably 60-100° C.
[D1] A method of manufacturing a fragrance-carrying constituent member of a flavor-generating article that comprises manufacturing a coating liquid in accordance with the method set forth in any one of [C1]-[C7]; and
applying the aforementioned coating liquid
   to the constituent member of the flavor-generating article.
[D2] The method set forth in [D1], wherein the aforementioned flavor-generating article is a flavor inhaler, preferably a heat-not-burn flavor inhaler.
[D3] The method set forth in [D1] or [D2], wherein the aforementioned constituent member of a flavor-generating article is a tobacco filler, a filter, or a cigarette rolling paper.
[D4] The method of any one of [D1]-[D3], wherein the aforementioned constituent member of a flavor-generating article is a shaped tobacco, a filter, or a cigarette rolling paper.
[D5] The method set forth in any one of [D1]-[D4], wherein the aforementioned constituent member of a flavor-generating article is a tobacco filler, preferably a shaped tobacco, and more preferably a sheet tobacco.
[E1] A coating liquid for coating a constituent member of a flavor-generating article that comprises particles, containing menthol and hydroxypropyl cellulose having a viscosity of 100 mPa·s or less at 20° C. in a 2 mass % aqueous solution, and glycerol as a dispersion medium.
[E2] The coating liquid set forth in [E1], having a transmittance of 10% or less over the entire wavelength range of 500-700 nm.
[E3] The coating liquid set forth in [E1] or [E2], wherein the aforementioned viscosity of the aforementioned hydroxypropyl cellulose is 50 mPa·s or less, preferably 30 mPa·s or less, more preferably 10 mPa·s or less, and still more preferably 6 mPa·s or less.
[E4] The coating liquid set forth in [E1] or [E2], wherein the aforementioned viscosity of the aforementioned hydroxypropyl cellulose is 1-100 mPa·s, preferably 1-50 mPa·s, more preferably 1-30 mPa s, still more preferably 1-10 mPa·s, still more preferably 2-10 mPa·s, and still more preferably 2-6 mPa.
[E5] The coating liquid set forth in any one of [E1]-[E4], wherein the aforementioned hydroxypropyl cellulose is mixed in the aforementioned menthol in the amount of 20-70 parts by mass, preferably 30-70 parts by mass, and more preferably 40-60 parts by mass to 100 parts by mass of the aforementioned menthol.
[E6] The coating liquid set forth in any one of [E1]-[E5], wherein the aforementioned glycerol is mixed with the mixture in the amount of 40-120 parts by mass, preferably 60-110 parts by mass, and more preferably 80-100 parts by mass to 100 parts by mass of the aforementioned menthol.
[E7] A coating liquid manufactured by the method set forth in any one of [C1]-[C7].

### EXAMPLES

### Example 1: Viscosity of the Coating Liquid

### [1-1] Coating Liquid Preparation

### (Coating Liquids 1A-1E)

Coating Liquids 1A-1E were prepared in accordance with the process shown in FIG. 2, with the following compositions (mass ratios).

| | |
|---|---|
| Coating Liquid 1A | HPC:menthol:glycerol = 2:5:0 |
| Coating Liquid 1B | HPC:menthol:glycerol = 2:5:1 |
| Coating Liquid 1C | HPC:menthol:glycerol = 2:5:2 |
| Coating Liquid 1D | HPC:menthol:glycerol = 2:5:3 |
| Coating Liquid 1E | HPC:menthol:glycerol = 2:5:4 |

Celny SSL (viscosity at 20° C. in a 2 mass % aqueous solution: 2.0-2.9 mPa·s, Nippon Soda Co., Ltd.) was used as the low-viscosity hydroxypropyl cellulose (hereinafter referred to as HPC) First, HPC and menthol (manufactured by Takasago International Corporation) were mixed in a mass ratio of 2:5 by stirring in a beaker in an 80° C. bath. HPC was thereby dissolved in the menthol. After that, glycerol (special grade reagent manufactured by Wako Pure Chemical Industries, Ltd.) was added to the mixture and mixed by stirring in an 80° C. bath. Coating Liquids 1A-1E were thus prepared.

### (Coating Liquids 2A-2E)

Coating Liquids 2A-2E were prepared in accordance with the same procedure as Coating Liquids 1A-1E, except that the compositions (mass ratios) of the coating liquids were changed as follows.

| | |
|---|---|
| Coating Liquid 2A | HPC:menthol:glycerol = 3:5:0 |
| Coating Liquid 2B | HPC:menthol:glycerol = 3:5:1 |
| Coating Liquid 2C | HPC:menthol:glycerol = 3:5:2 |
| Coating Liquid 2D | HPC:menthol:glycerol = 3:5:3 |
| Coating Liquid 2E | HPC:menthol:glycerol = 3:5:4 |

### (Coating Liquids 3A-3E)

Coating Liquids 3A-3E were prepared in accordance with the same procedure as Coating Liquids 1A-1E, except that a high-viscosity HPC, i.e. Celny H (with a viscosity of 1000-4000 mPa·s at 20° C. in a 2 mass % aqueous solution; Nippon Soda Co., Ltd.) was used as the HPC. Celny H has a higher viscosity than Celny SSL, and the blending ratio was therefore was reduced to 1/10.

The compositions (mass ratios) of the coating liquids 3A-3E were as shown below.

| | |
|---|---|
| Coating Liquid 3A | HPC:menthol:glycerol = 0.2:5:0 |
| Coating Liquid 3B | HPC:menthol:glycerol = 0.2:5:1 |
| Coating Liquid 3C | HPC:menthol:glycerol = 0.2:5:2 |
| Coating Liquid 3D | HPC:menthol:glycerol = 0.2:5:3 |
| Coating Liquid 3E | HPC:menthol:glycerol = 0.2:5:4 |

### (Coating Liquids 4A-4D)

Coating Liquids 4A-4D were prepared by the same procedure as Coating Liquids 3A-3E, except that the compositions (mass ratios) of the coating liquids were changed as follows.

| | |
|---|---|
| Coating Liquid 4A | HPC:menthol:glycerol = 0.3:5:0 |
| Coating Liquid 4B | HPC:menthol:glycerol = 0.3:5:1 |
| Coating Liquid 4C | HPC:menthol:glycerol = 0.3:5:2 |
| Coating Liquid 4D | HPC:menthol:glycerol = 0.3:5:3 |

### (Coating Liquids 5A-5B)

Coating Liquid 5A was prepared by mixing low-viscosity HPC (Celny SSL), menthol, and glycerol simultaneously, in a mass ratio of 2:5:4, by stirring in a beaker in an 80° C. bath.

In addition, Coating Liquid 5B was prepared by mixing low-viscosity HPC (Celny SSL), menthol, and glycerol simultaneously, in a mass ratio of 3:5:4, by stirring in a beaker in an 80° C. bath.

Solid matter was produced in Coating Liquids 5A and 5B. The solid matter is thought to have been a reaction product of glycerol and HPC. For this reason, the following viscosity measurements could not be performed with Coating Liquids 5A and 5B.

### [1-2] Viscosity Measurement

The viscosities (complex viscosities obtained by modulus measurement) of the Coating Liquids 1A-1E, 2A-2E, 3A-3E, and 4A-4D were measured by rheometer. A Haake RheoStress 1 (Thermo Scientific) was used as the rheometer. Viscosity was measured at 60° C.

### [1-3] Results

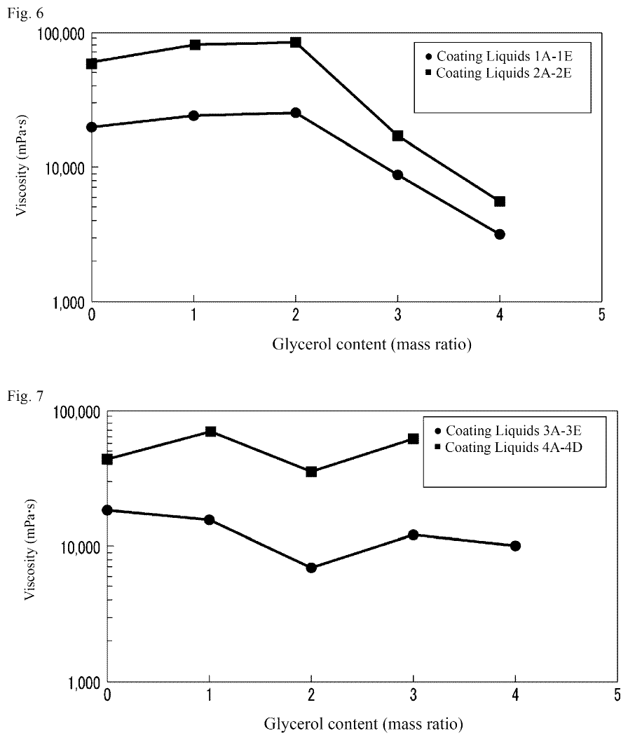

The viscosities of Coating Liquids 1A-1E and 2A-2E are shown in FIG. 6. The viscosities of Coating Liquids 3A-3E and 4A-4D are shown in FIG. 7. In FIGS. 6 and 7, the horizontal axis shows the mass ratio of the glycerol content when the menthol content is 5.

When low-viscosity HPC was used (FIG. 6), the viscosity of the coating liquid tended to decrease when the glycerol content exceeded a predetermined value (a mass ratio of 2). On the other hand, when high-viscosity HPC was used, no tendency for the viscosity of the coating liquid to decrease was noted even with an increased amount of glycerol admixed (FIG. 7).

### Example 2: Coating Liquid Menthol Aroma Retention

### [2-1] Coating Liquid Preparation

Coating Liquids 1A-1E, 2A-2E, 3A-3E, and 4A-4D were prepared as described above.

### [2-2] Evaluation of Menthol Aroma Retention

A filter paper strip (1×2 mm) was coated with a coating liquid, and stored for 2 weeks at room temperature in an open system. After storage for 2 weeks, menthol was extracted from the paper strip using methanol as an extraction solvent. The extract was analysed with a Gas Chromatography-Flame Ionization Detector (GC-FID) to determine the menthol content (M1). A 6890 Series GC-FID (DB-1 60 m×320 μm×1 μm (Agilent No. 123-1063)) was used as the GC-FID.

Similarly, the menthol content (M0) was determined by extraction of menthol from the filter paper strip and GC-FID analysis immediately after the coating liquid had been applied to the filter paper strip.

Menthol storage stability of (hereinafter referred to as “menthol aroma retention”) was calculated by the following formula.

$$Menthol aroma retention [ \% ] = ( M 1 / M 0 ) \times 100$$

### [2-3] Results

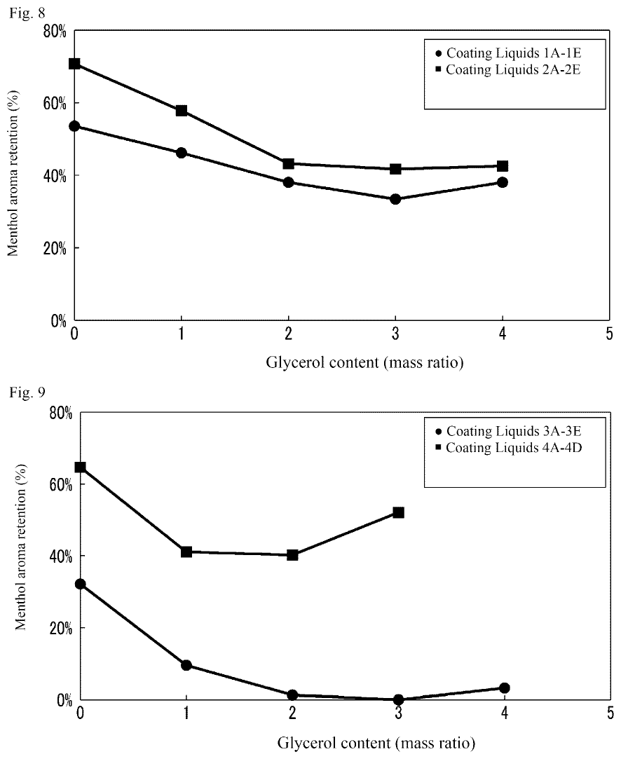

The menthol aroma retentions of Coating Liquids 1A-1E and 2A-2E are shown in FIG. 8. The menthol aroma retentions of Coating Liquids 3A-3E and 4A-4D are shown in FIG. 9. In FIGS. 8 and 9, the horizontal axis shows the mass ratio of the glycerol content when the menthol content is 5.

When low-viscosity HPC was used, menthol aroma retention was not significantly reduced by increasing the amount of glycerol admixed (FIG. 8). On the other hand, when high-viscosity HPC was used, menthol aroma retention significantly decreased with an increase in the amount of glycerol admixed in coating liquids (Coating Liquids 3A-3E) with a smaller amount of HPC admixed (FIG. 9). Nor did menthol aroma retention decrease greatly with increased amounts of glycerol admixed in coating liquids with a large amount of HPC had been added (coating liquids 4A-4D) when a high viscosity HPC was used (FIG. 9). However, having high viscosities, the coating liquids were thus difficult to apply to a constituent member of a flavor-generating article (see FIG. 7).

### [Example 3] Relationship Between Viscosity and Menthol Aroma Retention

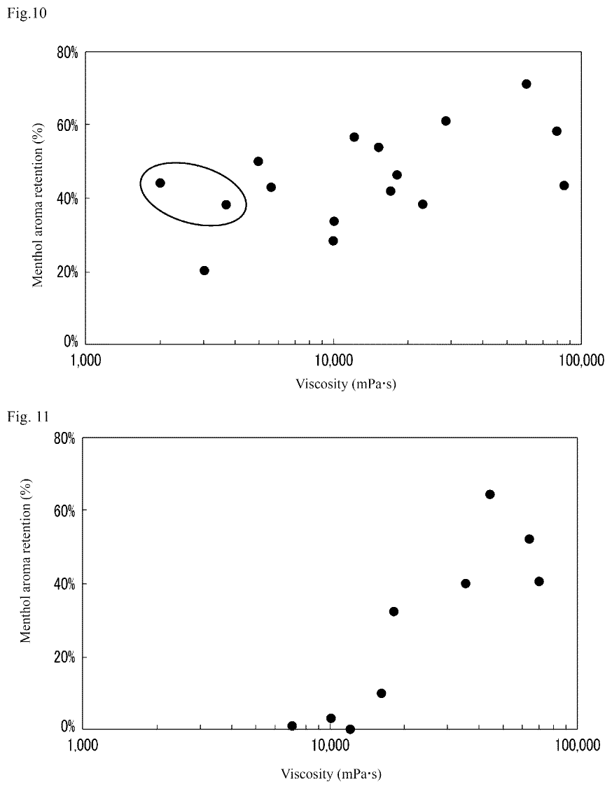

The relationship between viscosity and menthol aroma retention was graphed, based on the viscosity results in Example 1 and the menthol aroma retention results in Example 2. FIG. 10 shows the relationship between viscosity and menthol aroma retention when a low-viscosity HPC was used. FIG. 11 shows the relationship between viscosity and menthol aroma retention when a high-viscosity HPC was used.

From these results, it was found that a coating liquid can exhibit high menthol aroma retention despite having low viscosity. The data points for coating liquids capable of exhibiting high menthol aroma retention despite low viscosity are the two data points circled in FIG. 10. The compositions (mass ratios) of said coating liquid were as follows, starting from the lowest-viscosity coating liquid.
Celny SSL:menthol:glycerol=3:5:4 (Coating Liquid 2E)
Celny SSL:menthol:glycerol=2:5:4 (Coating Liquid 1E)

The attainment of both ease of application and fragrance storage stability in the abovementioned coating liquids is of particular excellence, given the difficulty of achieving both ease of application and fragrance storage stability in a coating liquid, since menthol aroma retention improves, in general, as the viscosity of a coating liquid increases.

In addition, the viscosity and menthol aroma retention of the coating liquids were investigated by a procedure similar to that in Examples 1 and 2, using propylene glycol instead of glycerol. However, when propylene glycol was used instead of glycerol, the menthol aroma retention of the coating liquid decreased with decreasing viscosity. That is, when propylene glycol was used instead of glycerol, it was not possible to prepare a coating liquid displaying low viscosity and high menthol aroma retention.

### [Example 4] Hydroxypropyl Cellulose Viscosity

The results in Example 1 (FIG. 6) indicate that when a low-viscosity HPC (Celny SSL) is used, the viscosity of the coating liquid tends to decrease when the glycerol content exceeds a predetermined value (a mass ratio of 2). Coating liquids with such reduced viscosity had a characteristically cloudy appearance. The cloudy coating liquid probably has particles comprising HPC and menthol dispersed colloidally in glycerol. Consequently, the coating liquids in Example 4 were prepared using HPC of a different viscosity, to see whether the abovementioned clouding would result.

### [4-1] Coating Liquid Preparation

The types of HPC used, sold by Nippon Soda Co., Ltd., were as follows. The viscosities shown in parentheses represent viscosity at 20° C. in a 2 mass % aqueous solution.
Celny SSL (2.0-2.9 mPa·s)
Celny SL (3.0-5.9 mPa·s)
Celny L (6.0-10.0 mPa·s)
Celny M (150-400 mPa·s)
Celny H (1000-4000 mPa·s)

Coating liquids of the following compositions (i.e., mass ratios) were prepared using the abovementioned HPC. The coating liquids were prepared by a procedure similar to that by which Coating Liquids 1A-1E were prepared in Example 1.
Coating Liquid 10A Celny SSL:menthol:glycerol=2:5:4 (Coating Liquid 10A is the same as Coating Liquid 1E in Example 1.)
Coating Liquid 10B Celny SSL:menthol:glycerol=3:5:4 (Coating Liquid 10B is the same as Coating Liquid 2E in example 1.)
Coating Liquid 10C Celny SL:menthol:glycerol=1:5:3
Coating Liquid 10D Celny L:menthol:glycerol=1:5:3
Coating Liquid 10E Celny M:menthol:glycerol=0.5:5:3
Coating Liquid 10F Celny H:menthol:glycerol=0.2:5:2
(Coating Liquid 10F is the same as Coating Liquid 3C in Example 1.)

A coating liquid 10G was also prepared as follows as a conventional coating liquid. Coating Liquid 10G was prepared by mixing low-viscosity HPC (Celny SSL), menthol, ethanol, propylene glycol, and glycerol simultaneously, in a mass ratio of 0.15:5:2.9:0.18:0.18, by stirring in a beaker in an 80° C. bath.

Coating Liquids 10H and 10I were also prepared by a procedure similar to that for Coating Liquids 5A and 5B in Example 1.

That is, Coating Liquid 10H was prepared by mixing low-viscosity HPC (Celny SSL), menthol, and glycerol simultaneously, in a mass ratio of 2:5:4, by stirring in a beaker in an 80° C. bath. In addition, Coating Liquid 10I was prepared by mixing low-viscosity HPC (Celny SSL), menthol, and glycerol simultaneously, in a mass ratio of 3:5:4, by stirring in a beaker in an 80° C. bath.

### [4-2] Transmittance Measurement

A UV-1800 UV spectrophotometer (manufactured by Shimadzu Corporation) was used to measure the transmittance of the coating liquids over a wavelength range of 500-700 nm. As a blank, the transmittance of tap water was measured over a wavelength range of 500-700 nm.

### [4-3] Results

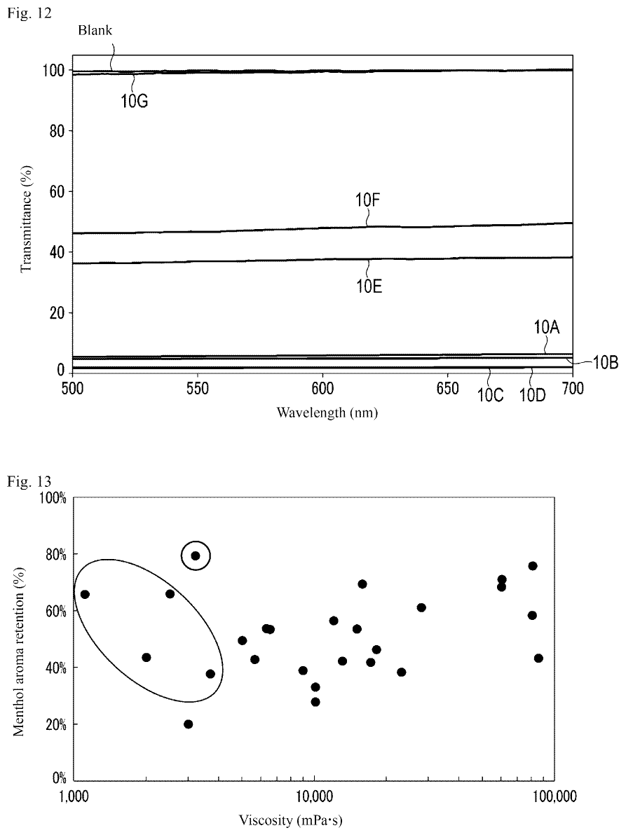

The measurement results are shown in Table 12. As shown in FIG. 12, the transmittance of each coating liquid and tap water (as a blank) was shown to be the constant value indicated below over the entire wavelength range of 500-700 nm. In addition, the respective coating liquids and tap water (as a blank) were observed with the unaided eye, and the cloudiness or transparency of the liquid noted in parentheses.
Coating Liquid 10A: Approximately 6% (cloudy)
Coating Liquid 10B: Approximately 5% (cloudy)
Coating Liquid 10C: Approximately 2% (cloudy)
Coating Liquid 10D: Approximately 2% (cloudy)
Coating Liquid 10E: Approximately 38% (quite transparent)
Coating Liquid 10F: Approximately 49% (quite transparent)
Coating Liquid 10G: Approximately 100% (completely transparent)
Coating Liquid 10H: Could not measure
Coating Liquid 10I: Could not measure
Tap water (blank): Approximately 100% (completely transparent)

Solid matter was produced in Coating Liquids 10H and 10I. The solid matter is thought to have been a reaction product of glycerol and HPC. For this reason, the transmittance of Coating Liquids 10H and 10I could not be measured.

The abovementioned results indicate that the coating liquid was cloudy when Celny SSL (2.0-2.9 mPa·s), Celny SL (3.0-5.9 mPa s), or Celny L (6.0-10.0 mPa·s) was used as the HPC. In view of these results, it is thought that a coating liquid clouds when an HPC with a viscosity, for example, of 100 mPa·s or less, preferably 50 mPa·s or less, more preferably 30 mPa·s or less, and still more preferably 10 mPa·s or less is used.

### [Example 5] Relationship Between Viscosity and Menthol Aroma Retention

Example 4 indicated that Celny SSL (2.0-2.9 mPa·s), Celny SL (3.0-5.9 mPa·s), and Celny L (6.0-10.0 mPa·s) are usable HPCs. Accordingly, in Example 5, these three types of HPC were used to prepare coating liquids of various compositions, to investigate the relationship between coating liquid viscosity and menthol aroma retention.

The coating liquid viscosity measurements and menthol aroma retention evaluation were performed by procedures similar to those in Examples 1 and 2. The relationship between viscosity of the coating liquid and the menthol aroma retention was similar to that in the graph of Example 3. The results are shown in FIG. 13. FIG. 13 also shows the results from Example 3 (i.e., the results from FIG. 10).

In view of the results in FIG. 13, it was found that a coating liquid could exhibit high menthol aroma retention despite low viscosity. The data points for coating liquids capable of exhibiting high menthol aroma retention despite low viscosity are the five data points circled in FIG. 13. The compositions (mass ratios) of said coating liquid were as follows, starting from the lowest-viscosity coating liquid.
Celny SSL:menthol:glycerol=3:5:5
Celny SSL:menthol:glycerol=3:5:4
Celny SSL:menthol:glycerol=2:5:5
Celny SSL:menthol:glycerol=2:5:4
Celny SL:menthol:glycerol=2:5:5

The attainment of both ease of application and fragrance storage stability in the abovementioned coating liquids is of particular excellence, given the difficulty of achieving both ease of application and fragrance storage stability in a coating liquid, since menthol aroma retention improves, in general, as the viscosity of a coating liquid increases.

### [Example 6] Inhalation Evaluation with a Heat-not-Burn Flavor Inhaler

In example 6, sheet tobacco was coated with the coating liquid to produce fragrance-carrying sheet tobacco, and inhalation evaluations were conducted with the fragrance-carrying sheet tobacco thus produced, incorporated into a tobacco stick.

### [6-1] Tobacco Stick Production

### Example of the Present Invention

Tobacco filler material (sheet tobacco) was extracted from a commercially available tobacco stick (see FIG. 4); the sheet tobacco was coated with 10 mg of a coating liquid having the following composition (mass ratio), and cooled. Thereby, a fragrance-carrying sheet tobacco 20A was produced.
Coating liquid Celny SSL:menthol:glycerol=2:5:4

Note that this coating liquid has the same composition as Coating Liquid 1E in example 1. The fragrance-carrying sheet tobacco 20A was reverted to the original tobacco stick to produce a tobacco stick 20A.

### Comparative Example

In a comparative example, a 100% menthol solution obtained by melting solid menthol was used as the coating liquid. Sheet tobacco was similarly coated with 10 mg of this coating liquid, and allowed to cool. Thereby, a fragrance-carrying sheet tobacco 20B was produced. The fragrance-carrying sheet tobacco 20B was reverted to the original tobacco stick to produce a tobacco stick 20B.

### [6-2] Evaluation of Menthol and Glycerol Contents

The tobacco sticks 20A and 20B were heated in the aerosol-generating device shown in FIGS. 3A-3C and 5, and inhalation was performed by an automatic smoker (i.e., a Borgwaldt RM-300). Smoke was collected with each puff. Smoke from each puff was collected using an impinger containing 10 mL of methanol cooled with dry ice.

The menthol and glycerol contents of the collected smoke were evaluated by GC measurement (Agilent 6890 Series GC-FID).

### [6-3] Results

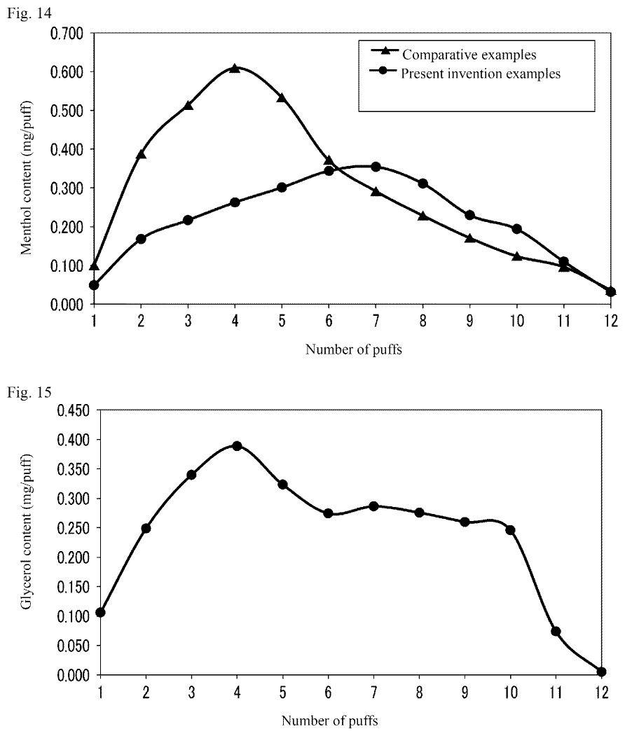

The relationship between the number of puffs and the menthol content is shown in FIG. 14. The relationship between the number of puffs and the glycerol content is shown in FIG. 15.

The menthol content of the smoke was such that a greater amount of menthol was released in later puffs with use of the examples of the present invention than with use of the comparative examples (when coated with a 100% menthol liquid). It was also confirmed that the amount of glycerol in the smoke was sufficient for the entire puff period up to the tenth puff.

It should be noted that the present invention is not limited to the above embodiments, and may be varied at the embodiment stage within a scope that does not depart from the gist thereof. The embodiments may also be implemented in combination as appropriate, in which case a combined effect is obtained. The abovementioned embodiments may also comprise various inventions, and various inventions may be derived by combination of constituent requirements selected from the plurality thereof that are disclosed. For example, even if some constituent requirements are omitted from among all of the constituent requirements indicated in an embodiment, a configuration in which that constituent requirement has been omitted may be derived as an invention if the problem of the invention can be solved and an effect is obtained.

### REFERENCE SIGNS LIST

1. fragrance-carrying sheet tobacco, 1a . . . sheet tobacco, 1b . . . fragrance composition, 100 . . . aerosol-generating device, 101 . . . outer housing, 102 . . . sliding cover, 103 . . . switch unit, 110 . . . inner housing, 120 . . . power source unit, 121 . . . power source, 130 . . . atomizing unit, 132 . . . insulating section, 134 . . . insertion guide member, 136 . . . bottom member, 137 . . . first holding unit, 138 . . . second holding unit, 140 . . . heater, 150 . . . chamber, 200 . . . tobacco stick, 201 . . . smokable material, 202 . . . first rolling paper, 203 . . . second rolling paper, 204 . . . tubular member, 205 . . . filter section, 206 . . . hollow filter section, 207 . . . lip release agent.

1. A fragrance-carrying constituent member of a flavor-generating article, comprising:
a constituent member of a flavor-generating article; and
a fragrance composition that is carried on the constituent member, containing particles that comprise menthol and a hydroxypropyl cellulose having a viscosity of 100 mPa·s or less at 20° C. in a 2 mass % aqueous solution, and glycerol as a dispersion medium.

2. The fragrance-carrying constituent member according to claim 1, wherein the hydroxypropyl cellulose content of the fragrance composition is 20-70 parts by mass to 100 parts by mass of the menthol.

3. The fragrance-carrying constituent member according to claim 1, wherein the glycerol content of the fragrance composition is 40-120 parts by mass to 100 parts by mass of the menthol.

4. The fragrance-carrying constituent member according to claim 1, wherein the constituent member of the flavor-generating article is a shaped tobacco, a filter, or a cigarette rolling paper.

5. A flavor-generating article comprising a fragrance-carrying constituent member according to claim 1.

6. A method of manufacturing a coating liquid for coating a constituent member of a flavor-generating article, comprising:
preparing a liquid mixture by mixing menthol and hydroxypropyl cellulose
having a viscosity of 100 mPa·s or less at 20° C. in a 2 mass % aqueous solution at a melting point of menthol or a higher temperature; and
mixing the liquid mixture with glycerol.

7. The method of manufacturing the coating liquid for coating the constituent member of a flavor-generating article according to claim 6, wherein the coating liquid has a transmittance of 10% or less over an entire wavelength range of 500-700 nm.

8. A method of manufacturing a fragrance-carrying constituent member of a flavor-generating article, comprising:
manufacturing a coating liquid in accordance with the method according to claim 6; and
applying the coating liquid to the constituent member of the flavor-generating article.

9. A coating liquid for coating a constituent member of a flavor-generating article, comprising:
particles containing menthol and hydroxypropyl cellulose having a viscosity of 100 mPa·s or less at 20° C. in a 2 mass % aqueous liquid; and
glycerol as a dispersion medium.

10. The coating liquid according to claim 9, having a transmittance of 10% or less over an entire wavelength range of 500-700 nm.

11. A coating liquid manufactured by the method according to claim 6.

12. The fragrance-carrying constituent member according to claim 1,
wherein the hydroxypropyl cellulose has a viscosity of 10 mPa·s or less at 20° C. in the 2 mass % aqueous solution.

13. The fragrance-carrying constituent member according to claim 12,
wherein the hydroxypropyl cellulose has a viscosity of 2-6 mPa·s at 20° C. in a 2 mass % aqueous solution.

14. The fragrance-carrying constituent member according to claim 1,
wherein the particles containing the menthol and the hydroxypropyl cellulose are colloidally dispersed in the glycerol.

15. The fragrance-carrying constituent member according to claim 4,
wherein the fragrance composition is present within voids of the constituent member.

16. The fragrance-carrying constituent member according to claim 1,
wherein the menthol and the hydroxypropyl cellulose are mixed at 60-100° C.

17. The method of manufacturing the fragrance-carrying constituent member of the flavor-generating article according to claim 8, further comprising:
drying the coated constituent member of the flavor-generating article at 15-25° C. until solidification.

18. The method of manufacturing the coating liquid for coating the constituent member of a flavor-generating article according to claim 6,
wherein preparing the liquid mixture by mixing the menthol and the hydroxypropyl cellulose is performed at 60-100° C.

19. The method of manufacturing the coating liquid for coating the constituent member of a flavor-generating article according to claim 18,
wherein mixing the liquid mixture with the glycerol is performed at substantially same temperature as the mixing of the menthol and the hydroxypropyl cellulose.

20. The method of manufacturing the coating liquid for coating the constituent member of a flavor-generating article according to claim 6,
wherein the coating liquid is prepared without simultaneously mixing the hydroxypropyl cellulose, the menthol, and the glycerol.
